(19) United States
(12) Patent Application Publication
(10) Pub. No.: US 2016/0354696 A1
(43) Pub. Date: Dec. 8, 2016

(54) SYSTEMS AND METHODS FOR PROVIDING ANONYMOUS GUEST PLAYERS IN A MULTIPLAYER ENVIRONMENT

(71) Applicant: Apple Inc., Cupertino, CA (US)

(72) Inventors: Nathan D. Taylor, Scotts Valley, CA (US); Edwin Iskandar, Cupertino, CA (US); Christopher K. Thomas, Cupertino, CA (US)

(21) Appl. No.: 14/732,572

(22) Filed: Jun. 5, 2015

(51) Int. Cl. A63F 13/795; A63F 13/235; A63F 13/533; A63F 13/95; A63F 13/77; A63F 13/34

(52) U.S. Cl. CPC A63F 13/795; A63F 13/77; A63F 13/34; A63F 13/533; A63F 13/95; A63F 13/235

(57) ABSTRACT

Methods, devices, and system for providing anonymous guest players for multiplayer applications are described. In one embodiment, a computer-implemented method includes initiating a game service for playing a multiplayer gaming application on a system, providing with a multiplayer API functionality for defining and adding an anonymous guest player to the system, generating data including a gaming invite that provides an ability to invite one or more friends that are registered with the game service and one or more anonymous guest players that are not registered with the game service. The method further includes receiving an input that identifies or selects an anonymous guest player to invite to play the multi-player gaming application on the system. The computer-implemented method further includes receiving data intended for the anonymous guest player from a different system of the multiplayer gaming application for peer to peer gaming applications.

### FIELD OF THE DISCLOSURE

This disclosure relates to system and methods for allowing, in one embodiment, players in a multiplayer environment.

### COMPUTER PROGRAM LISTING

A portion of the disclosure of this patent document contains material which is subject to copyright protection. The copyright owner has no objection to facsimile reproduction by anyone of the patent document or the patent disclosure, as it appears in the Patent & Trademark Office patent file or records, but otherwise reserves all copyright rights whatsoever.

Applicant has submitted herewith Computer Program Listings which are included as Appendix A, attached.

### BACKGROUND OF THE DISCLOSURE

Various devices such as electronic devices, computing systems, display screens, televisions, portable devices, and handheld devices are capable of allowing users to play and interact with software gaming applications. These devices can network with each other for a multiplayer gaming experience.

One prior gaming device allows players to interact with each other online. This gaming device allows the sharing of a game and accomplishments between players. A user with a game console accesses an online game service to share the gaming experience with other players.

However, this prior approach has limitations in terms of connecting players and playing games with other players.

### SUMMARY OF THE DESCRIPTION

At least certain embodiments of the present disclosure include one or more application programming interfaces in an environment with software interacting with one or more software applications. Various function calls or messages are transferred via the application programming interfaces between the software and software applications. At least certain embodiments of the present disclosure include a computer-implemented method for operating through one or more application programming interfaces (APIs). The computer-implemented method a computer-implemented method includes initiating a game service for playing a multiplayer gaming application on a system, providing with a multiplayer API functionality for defining and adding an anonymous guest player to the system, generating data including a gaming invite that provides an ability to invite one or more friends that are registered with the game service and one or more anonymous guest players that are not registered with the game service. The method further includes receiving an input that identifies or selects an anonymous guest player to invite to play the multi-player gaming application on the system. The computer-implemented method further includes receiving data intended for the anonymous guest player from a different system of the multiplayer gaming application for peer to peer gaming applications.

In certain embodiments, the number of devices involved in these methods may be greater than two. Various devices which perform one or more of the foregoing methods and machine readable media which, when executed by a processing system, cause the processing system to perform these methods, are also described.

Other methods, devices and machine readable media are also described.

### BRIEF DESCRIPTION OF THE DRAWINGS

The disclosure is described by way of example with reference to the accompanying drawings, wherein:

FIG. 1 illustrates a general network topology for supporting multiplayer software applications in accordance with one embodiment of the present disclosure;

FIG. 2 illustrates a framework (e.g., game framework) for supporting multi-device collaboration in a device or computing system in accordance with one embodiment of the present disclosure;

FIG. 3 is flow chart of a computer-implemented method for operating through one or more application programming interfaces (APIs) to add one or more guest players to a device or system in a multiplayer gaming environment in one embodiment of the present disclosure.

FIG. 4 is a block diagram illustrating an exemplary API architecture, which may be used in one embodiment of the present invention;

FIG. 5 is flow chart of a computer-implemented method for operating through one or more application programming interfaces (APIs) to programmatically add one or more guest players to a device or system in a multiplayer gaming environment in one embodiment of the present disclosure;

FIG. 6 illustrates a network diagram for providing multi-device collaboration (e.g., multiplayer gaming applications, music creation, document creation, etc.) in accordance with one embodiment of the present disclosure.

FIG. 7 illustrate an exemplary user interface (e.g., graphical user interfaces) provided by a game service module during a multiplayer gaming experience in one embodiment of the present invention;

FIG. 8 shows an embodiment of a wireless device which includes the capability for wireless communication;

FIG. 9 shows another example of a device in accordance with one embodiment of the present disclosure; and

In FIG. 10 (“Software Stack”), in one embodiment of the present invention, applications can make calls to Services A or B using several Service APIs and to Operating System (OS) using several OS APIs.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a through understanding of various embodiments of the present disclosure. However, in certain instances, well-known or conventional details are not described in order to provide a concise discussion of embodiments of the present disclosure.

Methods, systems, and devices for providing an environment for a multiplayer software application are described. In one embodiment, a computer-implemented method for operating through one or more application programming interfaces (APIs) includes initiating a multiplayer gaming application with a game service of a system, providing with a multiplayer API functionality for defining and adding an anonymous guest player to the user's system, and generating data including a gaming invite that provides an ability to invite one or more friends that are registered with the game service and one or more anonymous guest players that are not registered with the game service. The method further includes receiving a selection that identifies an anonymous guest player to invite to play the multi-player gaming application on the system. The method further includes transferring, with a real-time multiplayer API, a function call to send data to other participants of the multiplayer gaming application. The method further includes receiving data intended for the anonymous guest player from a different system of the multiplayer gaming application for peer to peer gaming applications. The method further includes receiving a notification for the anonymous guest player for a turn-based multiplayer gaming application. The one or more application programming interfaces (APIs) allow a game developer to develop a multiplayer gaming application for supporting local players only, remote players only, and local players with remote players without having different game modes for each of the local players only, remote players only, and local players with remote players.

The display region of a device is a form of a window. A window is a display region which may not have a border and may be the entire display region or area of a display. In some embodiments, a display region may have at least one window and/or at least one view (e.g., web, text, video, or image content). A window may have at least one view. The methods, systems, and apparatuses disclosed can be implemented with display regions, windows, and/or views.

At least certain embodiments of the disclosure may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on a media player, a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). In some embodiments, the display device and input device are integrated while in other embodiments the display device and input device are separate devices.

Embodiments of the disclosure described herein may be part of other types of data processing systems, such as, for example, entertainment systems or personal digital assistants (PDAs), or general purpose computer systems, or special purpose computer systems, or an embedded device within another device, or cellular telephones which do not include media players, or multi touch tablet devices, or other multi touch devices, or devices which combine aspects or functions of these devices (e.g., a media player, combined with a PDA, an entertainment system, and a cellular telephone in one device,). In this disclosure, electronic devices and consumer devices are types of devices.

In some embodiments, a platform provides various multiplayer applications, voice chat, service discovery, and networking operations. The platform includes hardware components and an operating system. The hardware components may include a processing unit coupled to an input panel and a memory coupled to the processor. The operating system includes one or more programs that are stored in the memory and configured to be executed by the processing unit. One or more programs may include various instructions for transferring function calls or messages through an application programming interface in order to perform various gaming, collaborative, voice chat, service discovery, and networking operations.

In some embodiments, the platform includes a framework containing a library of software code. The framework interacts with the programs of the platform to provide application programming interfaces (APIs) for performing various gaming, collaboration, voice chat, service discovery, and networking operations. The framework may also include associated resources (e.g., images, text, etc.) that are stored in a single directory.

An API is a source code interface that a computer system or program library provides in order to support requests for services from a software application. An API is specified in terms of a programming language that can be interpretative or compiled when an application is built, rather than an explicit low level description of how data is laid out in memory. The software that provides the functionality described by an API is said to be an implementation of the API.

Service discovery is performed by devices of a network (e.g., personal area network, local area network, wide area network) broadcasting services that they provide. One protocol by which service discovery may be performed is Bonjour. Other service discovery protocols can be used as well. Service discovery results in indication of services that are available via the personal area network and not necessarily the physical devices that provide the services. For example, a wireless device may utilize DNS formatted data over a Bluetooth connection to determine services that are available from other Bluetooth devices within range. Other combinations of formats and protocols may also provide service discovery in a similar manner.

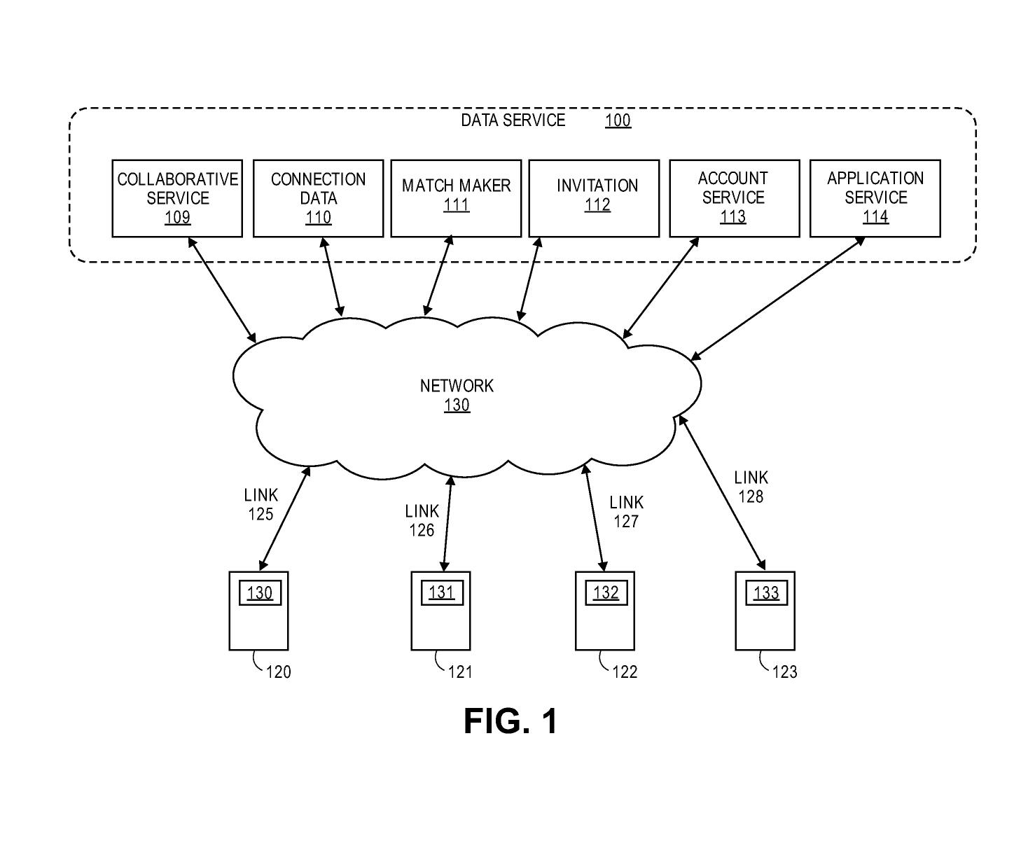

As illustrated in FIG. 1, a general network topology implemented in one embodiment of the present invention can include a group of “client” or “peer” computing systems 120-123, respectively, communicating with one another and with one or more services 109-114 over a network 130. Although illustrated as a single network cloud in FIG. 1, the “network” 130 can be comprised of a variety of different components including public networks such as the Internet and private networks such as local Wi-Fi networks (e.g., 802.11n home wireless networks or wireless hotspots), local area Ethernet networks, cellular data networks, and WiMAX networks, to name a few. For example, system 120 may be connected to a home Wi-Fi network represented by network link 125, system 121 may be connected to a 3G network (e.g., Universal Mobile Telecommunications System (“UMTS”), 4G network, High-Speed Uplink Packet Access (“HSUPA”), etc) represented by network link 126, system 122 may be connected to a WiMAX network represented by network link 127, and system 123 may be connected to a public Wi-Fi network represented by network link 128. Each of the local network links 125-128 over which the systems 120-123 are connected may be coupled to a public network such as the Internet, thereby enabling communication between the various systems 120-123 over the public network. However, if two systems are on the same local or private network (e.g., the same Wi-Fi network), then the two systems may communicate directly over that local/private network, bypassing the public network. It should be noted, of course, that the underlying principles of the present disclosure are not limited to any particular set of network types or network topologies.

Each of the systems 120-123 illustrated in FIG. 1 can communicate with a data service 100 that may include a collaborative service 109 (e.g., game service, music creation service, document creation service), a connection data exchange (CDX) service 110, a matchmaker service 111, an invitation service 112, an account service 113, and an application service 114. In one embodiment, the collaborative service 109 enables users to collaborate with collaborative applications. For example, the collaborative service 109 may be a game service that enables register users of the game service and anonymous guests (e.g., non-registered users) to collaborate for multiplayer software gaming applications. The game service may include or access any of the services 110-114 to provide a game service. For example, the game service may include services 111 and 112. The services 109-114 can be implemented as software executed across one or more physical computing systems such as servers. As shown in FIG. 1, in one embodiment, the services may be implemented within the context of a larger data service 100 managed by the same entity (e.g., the same company) and accessible by each of the systems 120-123 over the network 130. The data service 100 can include a local area network (e.g., an Ethernet-based LAN) connecting various types of servers, a storage area networks (“SANs”) and databases. In one embodiment, the databases store and manage data related to each of the user systems (e.g., client systems, computer systems, mobile systems) 120-123 and the users of those systems (e.g., user account data, system account data, user application data, etc.).

In one embodiment, a game service module 130-133 is located on each system 120-123. The game service module is associated with a game service software application that manages a game service in conjunction with the game service. The game service module includes sub-modules (e.g., profile, friends, games, notifications) for managing the game service and providing the gaming experience for multi-player gaming.

In one embodiment, the game service module 130-133 is implemented on a game framework. Additionally, in one embodiment, the friend service operations described herein (e.g., displaying friends lists, sending/receiving friend requests, etc) are managed by the friend service. For example, in one embodiment of the present invention, each user is identified within the friend service by either a unique destination signaling identifier (“DSID”) or a unique handle. In one embodiment, a DSID is used to identify users who are known to have accounts on the friend service. These users are sometimes referred to as “in-network users.” A handle can be used to identify users who are not known to have accounts on the friend service 100. These users are sometimes referred to as “out-of-network users.” This may include users who have not yet registered an account on the friend service and/or users who have an account on the friend service but who have not yet associated a particular handle with their account.

A “friend” may be defined as a user having an account that is associated or linked with an account from another user. For example, a “friend” may be defined as a user having a game service account that is associated or linked with a game service account from another user. The matchmaker service 111 can match two or more systems for a collaborative peer to peer (P2P) session based on a specified set of conditions. For example, users of two or more of the systems may be interested in playing a particular multiplayer game. In such a case, the matchmaker service 111 may identify a group of systems to participate in the game based on variables such as each user's level of expertise, the age of each of the users, the timing of the match requests, the particular game for which a match is requested and game-specific variables associated with the game. By way of example, and not limitation, the matchmaker service 111 may attempt to match users with similar levels of expertise at playing a particular game. Additionally, adults may be matched with other adults and children may be matched with other children. Moreover, the matchmaker service 111 may prioritize user requests based on the order in which those requests are received. The underlying principles of the present disclosure are not limited to any particular set of matching criteria or any particular type of P2P application.

In response to a match request, the matchmaker service 111 can coordinate with the CDX service 110 to ensure that all matched participants receive the necessary connection data for establishing P2P sessions in an efficient and secure manner.

In one embodiment, the invitation service 112 also identifies systems for participation in collaborative P2P sessions. However, in the case of the invitation service 112, at least one of the participants is specifically identified by another participant. For example, the user of system 120 may specifically request a collaborative session with the user of system 121. As with the matchmaker service 111, in response to an invitation request, the invitation service 112 can identify the set of participants and coordinate with the CDX service 110 to ensure that all participants receive the necessary connection data for establishing P2P sessions in an efficient and secure manner.

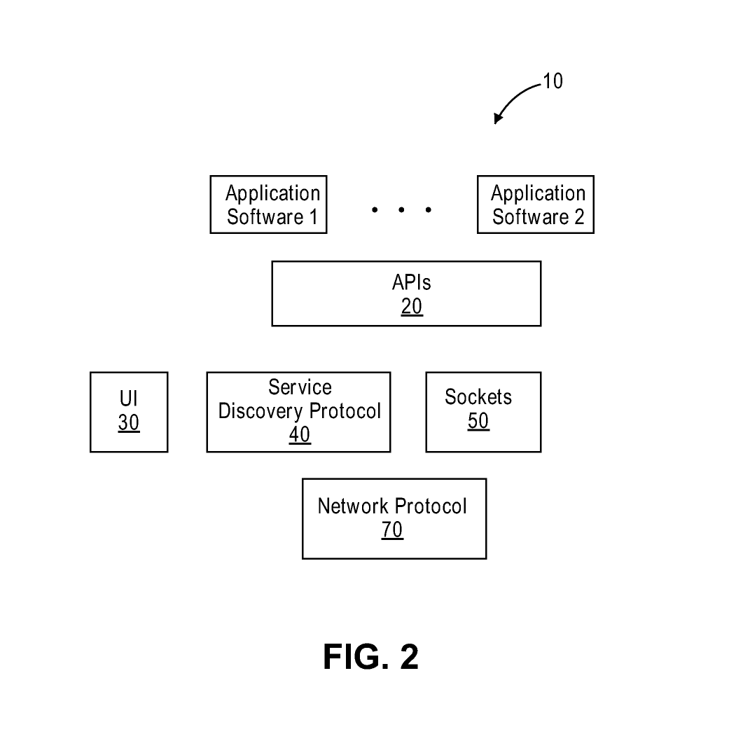

FIG. 2 illustrates a framework (e.g., game framework) for supporting multi-device collaboration in a device or computing system in accordance with one embodiment of the present disclosure. As noted elsewhere in this disclosure, multiplayer gaming is just one exemplary environment or use of the one or more embodiments of the invention. Multiplayer gaming applications include real-time applications in which game time progresses continuously according to the game clock. Players perform actions simultaneously as opposed to in sequential units or turns. Players must perform actions with the consideration that their opponents are actively working against them in real time. For turn-based applications, game flow is partitioned into well-defined and visible parts, called turns. A player of a turn-based game is allowed a period of analysis (sometimes bounded, sometimes unbounded) before committing to a game action, ensuring a separation between the game flow and the thinking process. The framework 10 includes APIs 20 (e.g., real-time multiplayer APIs (e.g., adding guest player to a match maker view controller, programmatically finding a match with guest players without a user interface, sending game data to other participants through match maker service 111 API, receiving data from other participants through match maker service 111 API), turn-based multiplayer APIs (e.g., adding guest players to the turn-based match maker view controller, programmatically finding a match with guest players without a user interface), game picker API, game connectivity API, collaborative kit session API, etc.) for providing an interface between the framework 10 and software applications (such as software application no. 1 and software application no. 2). For example, game developers can write software code of one or more gaming applications (such as software application no. 1 and software application no. 2) to call these APIs 20. A game connectivity API provides connectivity functionality using a UI (user interface) 30, a service discovery protocol 40 (e.g., Bonjour network services), sockets 50, and one or more network protocols 70 (e.g., Bluetooth, WiFi, cellular). Sockets 50 is a software construct that allows two processes to communicate with network addresses and ports.

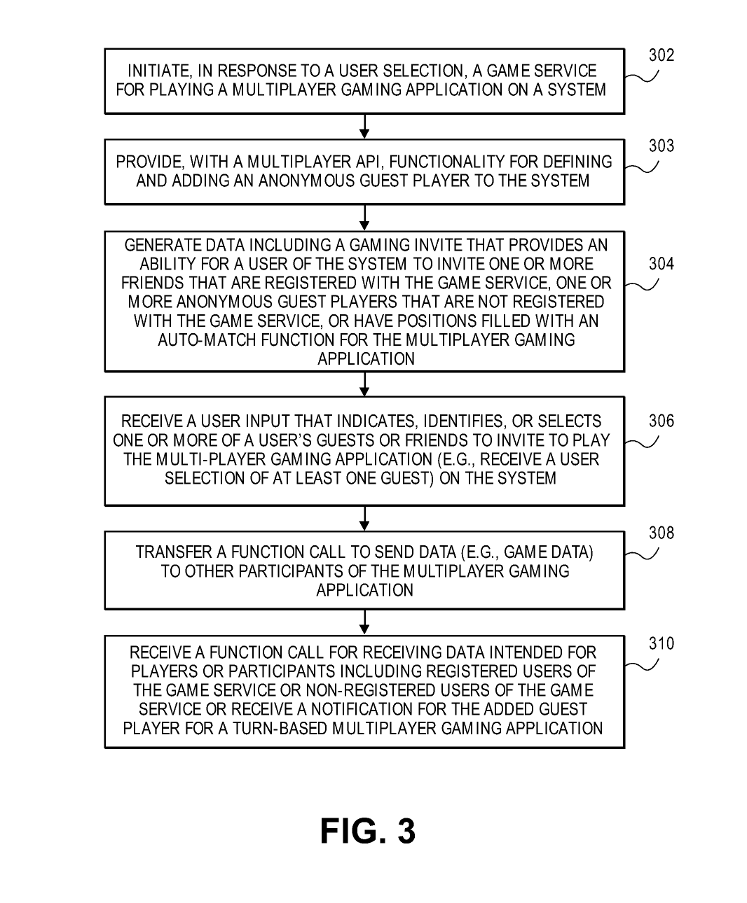

FIG. 3 is flow chart of a computer-implemented method for operating through one or more application programming interfaces (APIs) to add one or more guest players to a device or system in a multiplayer gaming environment in one embodiment of the present disclosure. The method operates in the multiplayer gaming environment having a framework with collaborative kit software interacting with one or more software applications (e.g., collaborative applications, gaming applications) on a first system and also collaborative kit software interacting with one or more software applications on a second system. The computer-implemented method 300 is performed by processing logic that may comprise hardware (circuitry, dedicated logic, etc.), software (such as is run on a general purpose computer system or a dedicated machine or a system), or a combination of both. In one embodiment, the computer-implemented method 300 is performed by the game service module 200 located on a client system.

At operation 302, processing logic in response to a user selection initiates a game service for playing a multiplayer gaming application on a system. The user of the system is registered with the game service (or collaborative kit software). At operation 303, a multiplayer API provides functionality for defining and adding an anonymous guest player to the system. In one example, a real-time multiplayer API (e.g., the real-time adding guest players to the matchmaker view controller API of Appendix A) provides the functionality for defining and adding an anonymous guest player to the user's system. The anonymous guest player is assigned a unique identifier and defined as being associated with the user or another player that is registered with the game service. In another example, a turn-based multiplayer API (e.g., turn-based adding guest players to the turn-based matchmaker view controller API of Appendix A) provides the functionality for defining and adding a guest player to the user's system. The anonymous guest player is assigned a unique identifier and defined as being associated with the user or another player that is registered with the game service. The game service is then aware that the user and the user's anonymous guest will be sharing the user's system.

At operation 304, the processing logic can generate data (e.g., presenting a graphical user interface of the game service to the user) including a gaming invite that provides an ability for the user of the system to invite one or more friends that are registered with the game service, one or more guests that are not registered with the game service, or have positions filled with an auto-match function for the multiplayer gaming application (e.g., real-time peer to peer multiplayer gaming applications, turn-based multiplayer gaming applications). The friends can be invited individually or simultaneously with invite option(s). At operation 306, the processing logic may receive a user input that indicates, identifies, or selects one or more of a user's guests or friends to invite to play the multi-player gaming application (e.g., receive a user selection of at least one guest) on the system.

At operation 308, the processing logic can transfer a function call to send data (e.g., game data) to participants or players of the multiplayer gaming application (e.g., real-time multiplayer gaming applications, turn-based multiplayer applications). In one example, a real-time multiplayer API (e.g., a real-time sending game data to other participants through a matchmaking service API of Appendix A) transfers a send data function call (e.g., send data function call to a subset of the participants, send data function call to all participants or players of the multiplayer application) from a first system to other systems participating in the multiplayer application. The other systems may have users registered with the game service or non-registered users (i.e., anonymous guests).

At operation 310, the processing logic can receive a function call for receiving data intended for participants or players of the multiplayer gaming application (e.g., real-time multiplayer gaming applications, turn-based multiplayer applications) including registered users of the game service or non-registered users of the game service. A non-registered user may include the added guest player and the data can be received from a different system (e.g., remote system, another local system) of the multiplayer gaming application for real-time gaming applications. Alternatively, at operation 310, the processing logic can receive a notification for the added guest player for a turn-based multiplayer gaming application. The notification may indicate any type of information relevant to the guest player (e.g., multiplayer application is ready or waiting for a turn of the guest player). A multi-player gaming application typically has a minimum and a maximum number of player slots or positions. Any empty positions that need to be filled and are not filled by friends or guests of the user can be automatically filled by the auto-matching function of the game service module or game service.

In one embodiment, in response to the user's selection of one or more friends or guests at operation 306, a series of invitation transactions may be implemented with the invitation service 112. Additionally, in one embodiment, in order to fill additional player slots or positions, a series of matchmaking transactions may be implemented with a matchmaking service 111. Anonymous guests (non-registered users) can be invited by the game service to register with the game service.

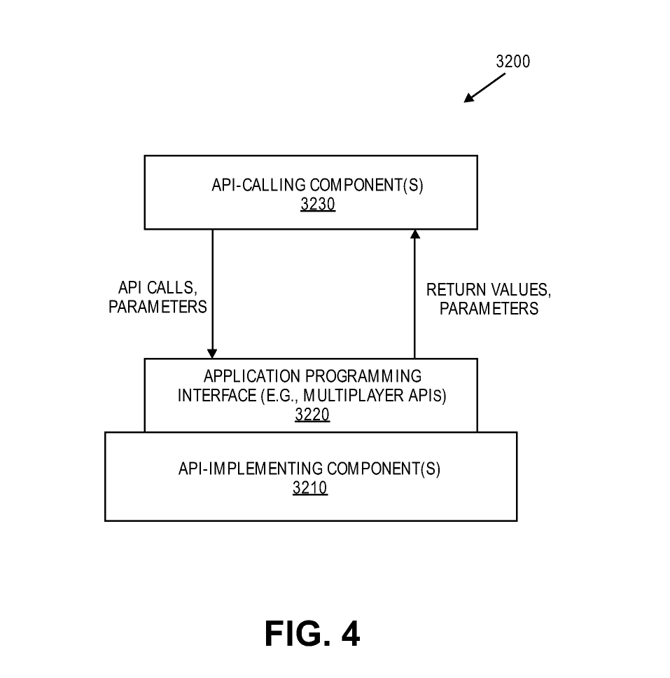

FIG. 4 is a block diagram illustrating an exemplary API architecture, which may be used in one embodiment of the present invention. As shown in FIG. 4, the API architecture 3200 includes the API-implementing component 3210 (e.g., an operating system, a library, a device driver, an API, an application program, software or other module) that implements the API 3220. The API 3220 (e.g., collaborative kit software, game kit software, real-time multiplayer APIs (e.g., adding guest player to a match maker view controller of Appendix A, programmatically finding a match with guest players without a user interface of Appendix A, sending game data to other participants through match maker service 111 API of Appendix A, receiving data from other participants through match maker service 111 API of Appendix A), turn-based multiplayer APIs (e.g., adding guest players to the turn-based match maker view controller of Appendix A, programmatically finding a match with guest players without a user interface of Appendix A)) specifies one or more functions, methods, classes, objects, protocols, data structures, formats and/or other features of the API-implementing component that may be used by the API-calling component 3230. The API 3220 can specify at least one calling convention that specifies how a function in the API-implementing component receives parameters from the API-calling component and how the function returns a result to the API-calling component. The API-calling component 3230 (e.g., an operating system, a library, a device driver, an API, multiplayer gaming applications, software or other module) makes API calls through the API 3220 to access and use the features of the API-implementing component 3210 that are specified by the API 3220. The API-implementing component 3210 may return a value through the API 3220 to the API-calling component 3230 in response to an API call.

It will be appreciated that the API-implementing component 3210 may include additional functions, methods, classes, data structures, and/or other features that are not specified through the API 3220 and are not available to the API-calling component 3230. It should be understood that the API-calling component 3230 may be on the same system as the API-implementing component 3210 or may be located remotely and accesses the API-implementing component 3210 using the API 3220 over a network. While FIG. 4 illustrates a single API-calling component 3230 interacting with the API 3220, it should be understood that other API-calling components, which may be written in different languages (or the same language) than the API-calling component 3230, may use the API 3220.

The API-implementing component 3210, the API 3220, and the API-calling component 3230 may be stored in a machine-readable medium (e.g., computer-readable medium), which includes any mechanism for storing information in a form readable by a machine (e.g., a computer or other data processing system). For example, a machine-readable medium includes magnetic disks, optical disks, random access memory; read only memory, flash memory devices, etc.

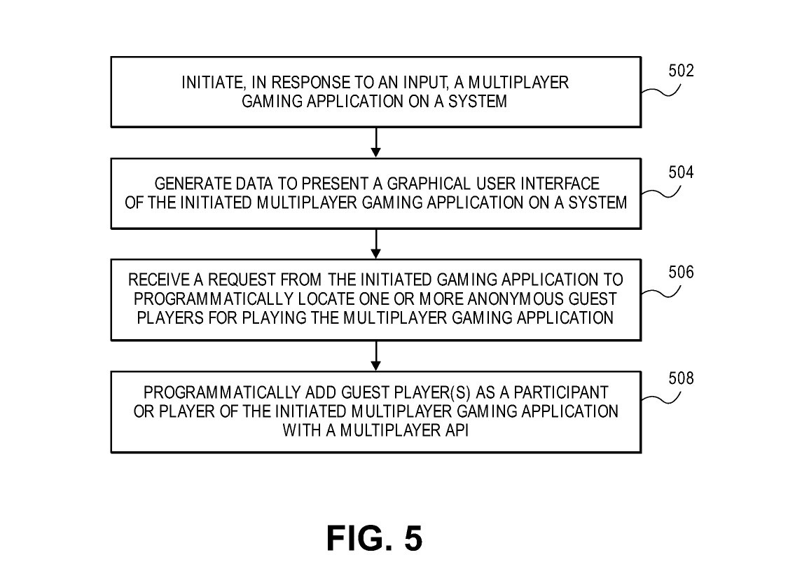

FIG. 5 is flow chart of a computer-implemented method for operating through one or more application programming interfaces (APIs) to programmatically add one or more guest players to a device or system in a multiplayer gaming environment in one embodiment of the present disclosure. The method operates in the multiplayer gaming environment having a framework with collaborative kit software (e.g., game service module) interacting with one or more software applications (e.g., collaborative applications, gaming applications) on a first system and also collaborative kit software (e.g., game service module) interacting with one or more software applications on a second system. The computer-implemented method 500 is performed by processing logic that may comprise hardware (circuitry, dedicated logic, etc.), software (such as is run on a general purpose computer system or a dedicated machine or a system), or a combination of both. In one embodiment, the computer-implemented method 500 is performed by the game service module 200 located on a client system.

At operation 502, processing logic in response to an input (e.g., selection, user selection) initiates a multiplayer gaming application on a system. The user of the system is registered with a game service (e.g., collaborative kit software, game service module). At optional operation 504, the processing logic can generate data to present a graphical user interface of the initiated multiplayer gaming application to the user. The data includes an option to provide an ability for the user of the system to request an addition of one or more guests that are not registered with the game service to the multiplayer gaming application. In one example, operation 504 is not included in method 500 and no user interface is needed for adding an anonymous guest player. At block 506, the processing logic may receive a request from the initiated gaming application (or from a different software application) to programmatically locate one or more anonymous guest players for playing the multiplayer gaming application. In one example, a real-time API (e.g., programmatically finding a match with guest players without a user interface API of Appendix A) provides the functionality for finding a guest player for adding to a user's system for playing the multiplayer gaming application. The anonymous guest player is assigned a unique identifier and defined as being associated with the user or another player that is registered with the game service. The guest player(s) is programmatically added as a participant or player of the initiated multiplayer gaming application at operation 508 with a multiplayer API. A developer can design a multiplayer gaming application to instantiate an anonymous guest player object of the game service within a user interface of the gaming application in order to add the anonymous guest player.

In another example, a turn-based API (e.g., programmatically finding a match with guest players without a user interface API of Appendix A) provides the functionality for finding a guest player for adding to a user's system for playing the multiplayer gaming application. The anonymous guest player is assigned a unique identifier and defined as being associated with the user or another player that is registered with the game service. The guest player(s) is programmatically added as a participant or player of the initiated multiplayer gaming application. The game service is then aware that the user and the user's anonymous guest(s) will be sharing the user's system. Anonymous guests (non-registered users) can be invited by the game service to register with the game service.

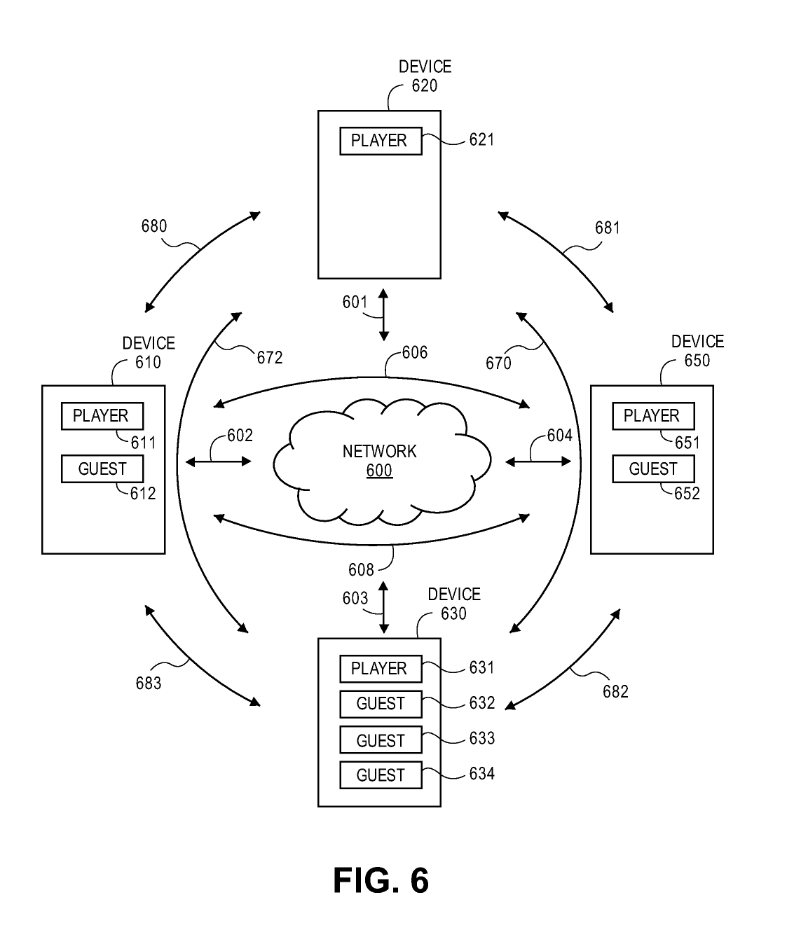

FIG. 6 illustrates a network diagram for providing multi-device collaboration (e.g., multiplayer gaming applications, music creation, document creation, etc.) in accordance with one embodiment of the present disclosure. A network 600 connects devices 610, 620, 630, and 650 via links 601-604, peer-to-peer connections 680-683, 606, 608, 670, and 672 connects the devices, or a combination of these network connections and peer connections are used for connectivity between these devices.

In one embodiment, these devices are collaborating with a collaborative application or multiplayer gaming application (e.g., war game, document creation, music creation, hockey, poker, etc). Multiplayer APIs are used to establish the connections between the devices. The multiplayer APIs can select between different types of connections (e.g., Bluetooth, WiFi, cellular). The devices operate in the multiplayer gaming environment having a framework with collaborative kit software interacting with one or more software applications (e.g., collaborative applications, gaming applications) on a first device and also collaborative kit software interacting with one or more software applications on a second device.

In one example, a user selection initiates a game service for playing a multiplayer gaming application on a device. The user of the device is registered with a game service (or collaborative kit software). Processing logic of the user's device can generate data to present a graphical user interface to the user. The data can include a gaming invite that provides an ability for the user of the device to invite one or more friends that are also registered with the game service, one or more anonymous guests that are not registered with the game service, or have positions filled with an auto-match function for the multiplayer gaming application (e.g., real-time peer to peer multiplayer gaming applications, turn-based multiplayer gaming applications). The friends can be invited individually or simultaneously with an invite option. Processing logic of the device may receive a user selection that identifies one or more of a user's anonymous guests or friends to invite to play the multi-player gaming application (e.g., receive a user selection of at least one guest) on the device. In one example, the real-time adding guest players to the matchmaker view controller API provides the functionality for defining and adding a guest player to the user's device. The anonymous guest player is assigned a unique identifier and defined as being associated with the user or another player that is registered with the game service. In this example, a player 611 of device 610 adds an anonymous guest 612 to the device 610. In this manner, the player 611 and the anonymous guest 612 can both play the multiplayer application using the device 610. A player 621 is registered with the game service module and uses the device 620. A player 651 is registered with the game service module and uses the device 650. Player 651 of device 650 adds an anonymous guest 652 to the device 650. In this manner, the player 651 and the anonymous guest 652 can both play the multiplayer application using the device 650.

In a similar manner, a player 631 is registered with the game service module and uses the device 630. Player 631 of device 630 adds anonymous guests 632-634 to the device 630. In this manner, the player 631 and the anonymous guests 632-634 can both play the multiplayer application using the device 630.

In another example, a turn-based multiplayer API (e.g., turn-based adding guest players to the turn-based matchmaker view controller API) provides the functionality for defining and adding a guest player to the user's device. An anonymous guest player is assigned a unique identifier and defined as being associated with the user or another player that is registered with the game service. The game service is then aware that the user and the user's anonymous guest will be sharing the user's device.

Processing logic of any of the devices can transfer a function call to send data (e.g., game data, players whether registered or non-registered, messages) to other participants of the multiplayer gaming application. In one example, a real-time multiplayer API (e.g., a real-time sending game data to other participants through a matchmaking service API) transfers a send data function call (e.g., send data function call to a subset of the participants, send data function call to all participants or players of the multiplayer application) to other devices participating in the multiplayer application. The other devices may have users (e.g., players) registered with the game service or non-registered users (i.e., anonymous guests). The processing logic of any of the devices can receive a function call for receiving data intended for other participants including registered users of the game service or non-registered users of the game service. A non-registered user may include the added guest player and the data can be received from a different device (e.g., remote device, another local device) of the multiplayer gaming application for real-time gaming applications.

Alternatively, processing logic of any of the devices having an anonymous guest player can receive a notification for the added guest player for a turn-based multiplayer gaming application. The notification may indicate any type of information relevant to the guest player (e.g., multiplayer application is ready or waiting for a turn of the guest player). A multi-player gaming application typically has a minimum and a maximum number of player slots or positions. Any empty positions that need to be filled and are not filled by friends of the user can be automatically filled by the auto-matching function of the game service module or game service.

The registered players and anonymous guest players can communicate (e.g., text messaging, messaging, video chat, phone call, etc.) with each other using the game service or other communication means.

In one example, the devices 610, 620, 630, and 650 are remotely located from each other and need to access a wide area network (e.g., Internet) to connect with each other. In another example, devices 610 and 620 are local to each other (e.g., in same room, same residence, same local area network, etc.) while devices 630 and 650 are remotely located. In another example, all devices are local to each other.

Prior approaches would require developers to provide three different game modes and three different sets of software code respectively for supporting local players only, remote players only, and local players with remote players.

In contrast, the one or more application programming interfaces (APIs) (e.g., multiplayer APIs, game service module) of the present disclosure allow a developer (e.g., game developer) to develop a multiplayer gaming application with a single game mode and single set of software code for supporting local players only, remote players only, and local players with remote players without having different game modes for each of the local players only, remote players only, and local players with remote players.

In other example, a subset of the devices illustrated in FIG. 6 are participating in a multiplayer gaming application. For example, only device 630 with player 631 and guests 632-634 may be participating in a multiplayer gaming application. In another example, only devices 610 and 620 are participating in a multiplayer gaming application. For an individual device, a player and one or more guests share the device (e.g., mobile device, tablet device, display screen, television, etc.) for real-time applications with simultaneous player interactions and also for turn-based multiplayer gaming applications. The players registered with the game service have full access to features of the game service including friend lists, leaderboards, achievements, messaging, etc. while the anonymous guests have access to a limited set of features including participating or playing in a particular multiplayer application, messaging, nicknames, images (e.g., icon images) without access to all features of the game service (e.g., friend lists, leaderboards, achievements).

In one example, an anonymous guest for a first device may want to be an anonymous guest for a second device. The anonymous guest will need to be added as anonymous guest for the second device. In another example, an anonymous guest for a first device is automatically prepopulated as an anonymous guest for a second device if a user(s) of the first and second devices are registered with the game service or if the user are associated with each other.

In another example, an anonymous guest for a device and a first game while continue to be anonymous guest for the first game even after the game ends for the anonymous guests. Later initiation of the first game will result in the anonymous guest being automatically added. In another example, an anonymous guest for a device and a first game will not be automatically added to a second game of the device. In another example, an anonymous guest for a device and a first game will be automatically added to a second game of the device. The anonymous guest is persistent across different games. A list or arrangement of guest players can be provided across different games for selection of one or more anonymous guest players. In this case, a registered player may not want to login into the game service. The registered player can instead join the multiplayer gaming application as an anonymous guest player.

In another embodiment, a first device is shared between a first player and a first guest, a second device is shared between a second player and a second guest, and a third device is shared between a third player and a third guest. At the time of initiating the multiplayer gaming application or during the multiplayer gaming application, the third player may decide not to player. The third guest is still allowed to play using the third device while the third player is deactivated.

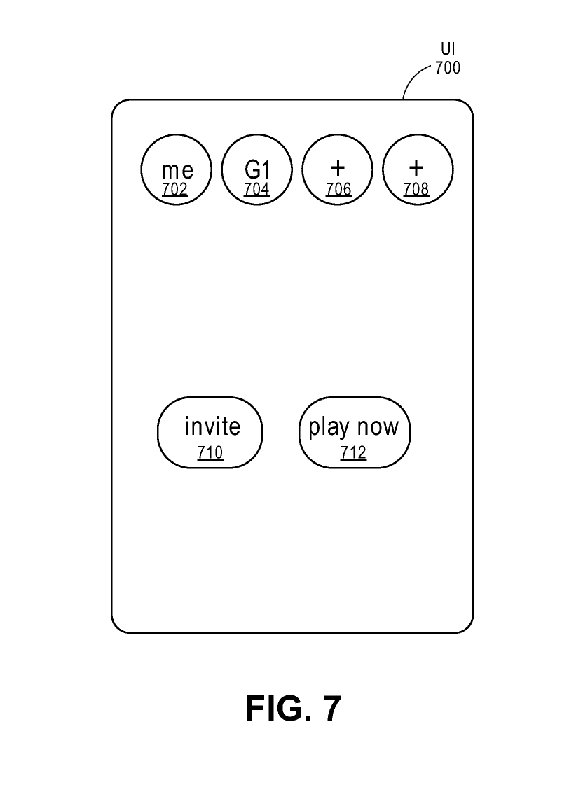

FIG. 7 illustrate an exemplary user interface (e.g., graphical user interface) provided by a game service module during a multiplayer gaming experience in one embodiment of the present invention. After, during, or prior to initiating a multiplayer gaming application, the user interface 700 is generated to allow the user (e.g., me) to invite between a minimum and a maximum number of players for the multiplayer game. The user interface 700 includes data for identifying players or anonymous guest players for the multiplayer gaming application. The data includes a user option (e.g., me option 702), an anonymous guest option 704, and options 706 and 708 for auto-match positions obtained by a match making service. Selection of an invite option 710 causes a user interface to be generated that includes a list of the user's friends within the game service that can be invited individually or simultaneously for playing the multiplayer game with the user. A user can select a play now option 712 to begin the multiplayer application with G1 and any players added with auto-matching. The multiplayer game in this example requires 4 players. In other embodiments, fewer than 4 players may be needed or more than 4 players may be allowed. The players and anonymous guest players may have established peer to peer connections at this time of waiting in a “lobby” for the players to be assembled. The players and anonymous guest players may exchange messages or chat with each other. The user can control the lobby environment and mute and/or alter player volume levels.

The matchmaker service can perform the auto-matching and can select auto-match players based on various factors (e.g., player skill level, leaderboard rankings, achievement score, user's ratings, location, time zone, players that are ready to play, age, etc.).

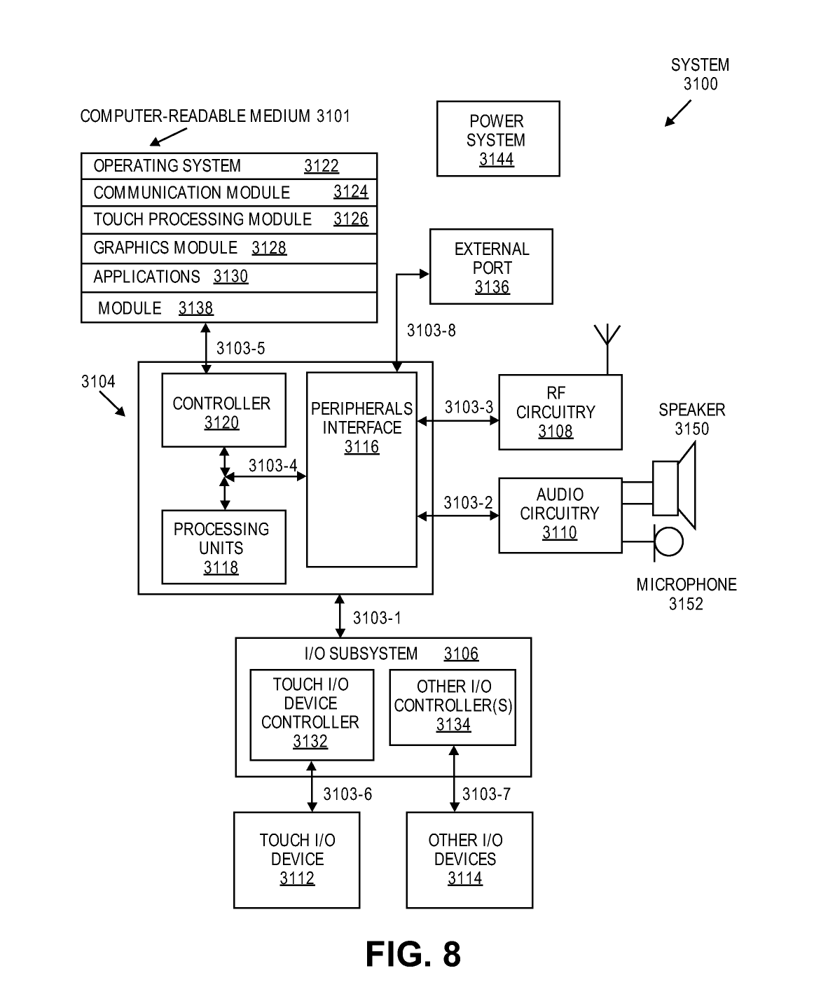

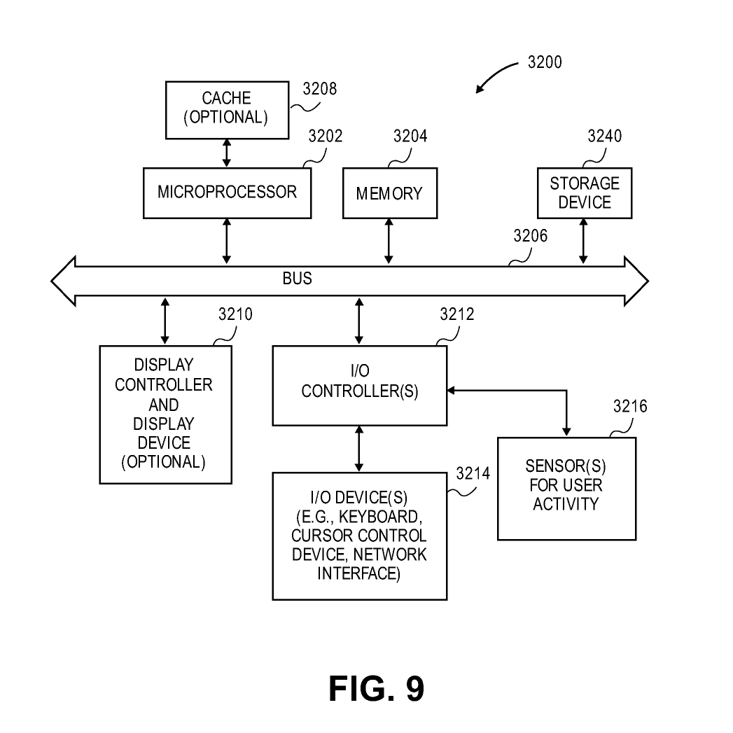

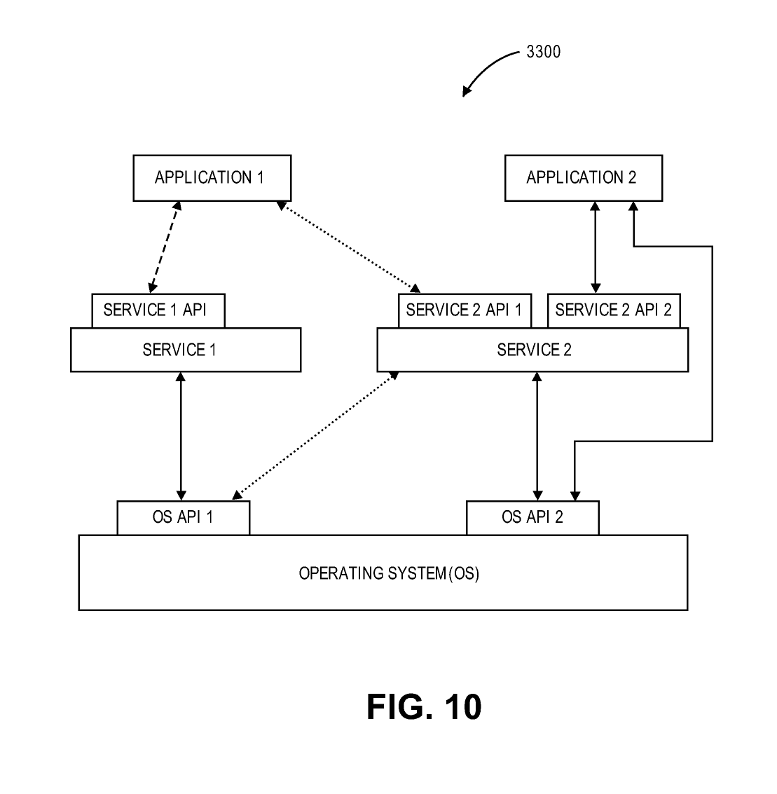

In some embodiments, the methods, systems, and apparatuses of the present disclosure can be implemented in various devices including electronic devices, consumer devices, data processing devices, desktop computers, portable computers, wireless devices, cellular devices, tablet devices, display screens, televisions, handheld devices, multi touch devices, multi touch data processing devices, any combination of these devices, or other like devices. FIGS. 8 and 9 illustrate examples of a few of these devices.

Attention is now directed towards embodiments of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, a television, or any other system or device adaptable to the inclusion of system architecture 3100, including combinations of two or more of these types of devices.

FIG. 8 is a block diagram of one embodiment of the present invention of system 3100 that generally includes one or more computer-readable mediums 3101, processing system 3104, Input/Output (I/O) subsystem 3106, radio frequency (RF) circuitry 3108 and audio circuitry 3110. These components may be coupled by one or more communication buses or signal lines 3103.

It should be apparent that the architecture shown in FIG. 31 is only one example architecture of system 3100, and that system 3100 could have more or fewer components than shown, or a different configuration of components. The various components shown in FIG. 31 can be implemented in hardware, software, firmware or any combination thereof, including one or more signal processing and/or application specific integrated circuits.

RF circuitry 3108 is used to send and receive information over a wireless link or network to one or more other devices and includes well-known circuitry for performing this function. RF circuitry 3108 and audio circuitry 3110 are coupled to processing system 3104 via peripherals interface 3116. Interface 3116 includes various known components for establishing and maintaining communication between peripherals and processing system 3104. Audio circuitry 3110 is coupled to audio speaker 3150 and microphone 3152 and includes known circuitry for processing voice signals received from interface 3116 to enable a user to communicate in real-time with other users. In some embodiments, audio circuitry 3110 includes a headphone jack (not shown).

Peripherals interface 3116 couples the input and output peripherals of the system to processing units 3118 and computer-readable medium 3101. One or more processing units 3118 communicate with one or more computer-readable mediums 3101 via controller 3120. Computer-readable medium 3101 can be any device or medium (e.g., storage device, storage medium) that can store code and/or data for use by one or more processing units 3118. Medium 3101 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 3101 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processing units 3118 run various software components stored in medium 3101 to perform various functions for system 3100. In some embodiments, the software components include operating system 3122, communication module (or set of instructions) 3124, touch processing module (or set of instructions) 3126, graphics module (or set of instructions) 3128, one or more applications (or set of instructions) 3130, and game service module [or set of instructions] 3138. In an embodiment, a game service application is associated with a game center module 3138 that includes sub-modules (e.g., profiles module, friends module, games module, notifications module). Each of these modules, sub-modules, and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various embodiments.

In some embodiments, medium 3101 may store a subset of the modules and data structures identified above. Furthermore, medium 3101 may store additional modules and data structures not described above.

Operating system 3122 includes various procedures, sets of instructions, software components and/or drivers for controlling and managing general system tasks (e.g., memory management, storage device control, power management, etc.) and facilitates communication between various hardware and software components.

Communication module 3124 facilitates communication with other devices over one or more external ports 3136 or via RF circuitry 3108 and includes various software components for handling data received from RF circuitry 3108 and/or external port 3136.

Graphics module 3128 includes various known software components for rendering, animating and displaying graphical objects on a display surface. In embodiments in which touch I/O device 3112 is a touch sensitive display (e.g., touch screen), graphics module 3128 includes components for rendering, displaying, and animating objects on the touch sensitive display.

One or more applications 3130 can include any applications installed on system 3100, including without limitation, a game center application, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 3126 includes various software components for performing various tasks associated with touch I/O device 3112 including but not limited to receiving and processing touch input received from I/O device 3112 via touch I/O device controller 3132.

System 3100 may further include game service module 3138 having sub-modules (e.g., profile module, friends module, games module, notifications module) for performing the method/functions as described herein in connection with FIGS. 1-7. In one embodiment, the game service module 3138 may at least function to provide a multiplayer gaming environment with an ability to add anonymous guest players. The processing system may be configured to execute instructions of the game service module 3130 (or instructions of multiplayer APIs of the game service module) to initiate a multiplayer gaming application with the game service module, to generate data to present a graphical user interface of the wireless device, and to receive a user selection that identifies an anonymous guest player to invite to play the multi-player gaming application on the wireless device. The data includes a gaming invite that provides an ability to invite one or more friends that are registered with the game service module and one or more anonymous guest players that are not registered with the game service module. In one example, the processing system is further configured to execute instructions of the one or more software programs (e.g., game service module 3138) to transfer, with a real-time multiplayer API of the game service module, a function call to send data to other participants of the multiplayer gaming application.

The processing system is further configured to execute instructions of the one or more software programs to receive data intended for the anonymous guest player from a different system of the multiplayer gaming application for peer to peer gaming applications. The processing system can be further configured to execute instructions of the one or more software programs to receive a notification for the anonymous guest player for a turn-based multiplayer gaming application. The notification indicates that the multiplayer gaming application is ready or waiting for a turn of the anonymous guest player. The multiplayer APIs allow a game developer to develop a multiplayer gaming application for supporting local players only, remote players only, and local players with remote players without having different game modes for each of the local players only, remote players only, and local players with remote players.

FIG. 9 shows another example of a device according to an embodiment of the disclosure. This device 3200 may include one or more processors, such as microprocessor(s) 3202, and a memory 3204, which are coupled to each other through a bus 3206. The device 3200 may optionally include a cache 3208 which is coupled to the microprocessor(s) 3202. The device may optionally includes a storage device 3240 which may be, for example, any type of solid-state or magnetic memory device. Storage device 3240 may be or include a machine-readable medium.

This device may also optionally include a display controller and display device 3210 which is coupled to the other components through the bus 3206. One or more input/output controllers 3212 are also coupled to the bus 3206 to provide an interface for input/output devices 3214 and to provide an interface for one or more sensors 3216 which are for sensing user activity. The bus 3206 may include one or more buses connected to each other through various bridges, controllers, and/or adapters as is well known in the art. The input/output devices 3214 may include a keypad or keyboard or a cursor control device such as a touch input panel. Furthermore, the input/output devices 3214 may include a network interface which is either for a wired network or a wireless network (e.g. an RF transceiver). The sensors 3216 may be any one of the sensors described herein including, for example, a proximity sensor or an ambient light sensor. In at least certain implementations of the device 3200, the microprocessor(s) 3202 may receive data from one or more sensors 3216 and may perform the analysis of that data in the manner described herein.

In certain embodiments of the present disclosure, the device 3200 or device 3100 or combinations of devices 3100 and 3200 can be used to implement at least some of the methods discussed in the present disclosure.

In FIG. 10 (“Software Stack”), in one embodiment of the present invention, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2. In one example, applications 1 and 2 are multiplayer gaming applications while service 1 represents a collaborative service (e.g., game service). Service 2 may also be a collaborative service (e.g., game service) or a different type of service.

Some portions of the detailed descriptions are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing or transmitting information in a form readable by a machine (e.g., a computer). For example, machines store and communicate (internally and with other devices over a network) code and data using machine-readable media, such as machine storage media (e.g., magnetic disks; optical disks; random access memory; read only memory; flash memory devices; phase-change memory).

In the foregoing specification, the disclosure has been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

APPENDIX A
MULTIPLAYER APIs

Realtime multiplayer API
---- Realtime: Adding guest players to the matchmaker view controller:
// add 2 guest players to the match request
let guestPlayer1: GKPlayer! =
GKPlayer.anonymousGuestPlayerWithIdentifier(″guest1”)
let guestPlayer2: GKPlayer! =
GKPlayer.anonymousGuestPlayerWithIdentifier(″guest2″)
matchRequest.recipients = [guestPlayer1, guestPlayer2]
self.matchmakerViewController =
GKMatchmakerViewController(matchRequest: matchRequest)
---- Realtime: programmatically finding a match with guest players without a UI
GKMatchmaker.sharedMatchmaker( ).findMatchForRequest(matchRequest, withCompletionHandler: { (match: GKMatch?, error:
NSError?) -> Void in

// do something with the match

})

---- Realtime: Sending game data to other participants through GKMatch
// Asynchronously send data to one or more GKPlayers. Returns YES if delivery started, NO if unable to start sending and error will be
set. Player here can be a guest player.
func sendData(data: NSData, toPlayers players: [GKPlayer], dataMode mode: GKMatchSendDataMode, error: NSErrorPointer) -> Bool
// Asynchronously broadcasts data to all players. Returns YES if delivery started, NO if unable to start sending and error will be set.
func sendDataToAUPlayers(data: NSData, withDataMode mode: GKMatchSendDataMode, error: NSErrorPointer) -> Bool
---- Realtime: Receiving data from other participants through GKMatch
// The match received data sent from a remote player. Recipient here can be a guest player.
func match(match: GKMatch, didReceiveData data: NSData, forRecipient recipient: GKPlayer, fromRemotePlayer player: GKPlayer)
Turn-based multiplayer API
---- Turn-based: Adding guest players to the turn based matchmaker view controller
GKTurnBasedMatchmakerViewController(matchRequest: matchRequest)
---- Turn-based: Programmatically finding a match with guest players without a UI
GKTurnBasedMatch.findMatchForRequest(matchRequest, withCompletionHandler: { (match: GKTurnBasedMatch?, error: NSError?) -
> Void in

// do something with the match

})

What is claimed is:

1. A computer-implemented method for operating through one or more application programming interfaces (APIs), the computer-implemented method comprises:
initiating, with a system, a game service for playing a multiplayer gaming application;
providing, with a multiplayer API of the game service, functionality for defining and adding an anonymous guest player to the system;
generating data including a gaming invite that provides an ability to invite one or more friends that are registered with the game service and one or more anonymous guest players that are not registered with the game service; and
receiving an input that selects or identifies an anonymous guest player to invite to play the multi-player gaming application on the system.

2. The computer-implemented method of claim 1, further comprising:
transferring, with a real-time multiplayer API, a function call to send data to players or participants of the multiplayer gaming application.

3. The computer-implemented method of claim 1, further comprising:
receiving data intended for the anonymous guest player from a different system of the multiplayer gaming application for peer to peer gaming applications.

4. The computer-implemented method of claim 1, further comprising:
receiving a notification for the anonymous guest player for a turn-based multiplayer gaming application.

5. The computer-implemented method of claim 4, wherein the notification indicates that the multiplayer gaming application is ready or waiting for a turn of the anonymous guest player.

6. The computer-implemented method of claim 1, wherein the one or more application programming interfaces (APIs) allow a game developer to develop a multiplayer gaming application for supporting local players only, remote players only, and local players with remote players without having different game modes for each of the local players only, remote players only, and local players with remote players.

7. A machine-readable medium storing executable program instructions which when executed cause a processing system to perform a method comprising:
initiating, with a system, a game service for playing a multiplayer gaming application;
providing, with a multiplayer API of the game service, functionality for defining and adding an anonymous guest player to the system;
generating data including a gaming invite that provides an ability to invite one or more friends that are registered with the game service and one or more anonymous guest players that are not registered with the game service; and
receiving an input that selects or identifies an anonymous guest player to invite to play the multi-player gaming application on the system.

8. The machine-readable medium of claim 7, the method further comprising:
transferring, with a real-time multiplayer API, a function call to send data to players or participants of the multiplayer gaming application.

9. The machine-readable medium of claim 7, the method further comprising:
receiving data intended for the anonymous guest player from a different system of the multiplayer gaming application.

10. The machine-readable medium of claim 7, the method further comprising:
receiving a notification for the anonymous guest player for a turn-based multiplayer gaming application, wherein the notification indicates that the multiplayer gaming application is ready or waiting for a turn of the anonymous guest player.

11. The machine-readable medium of claim 7, wherein the method operates through one or more application programming interfaces (APIs) to allow a game developer to develop a multiplayer gaming application for supporting local players only, remote players only, and local players with remote players without having different game modes for each of the local players, remote players, and local players with remote players.

12. A wireless device comprises:
a storage medium to store one or more software programs including a game service module having multiplayer application programming interfaces (APIs);
a processing system to execute instructions of the one or more software programs, the processing system is configured to execute instructions of the one or more software programs to initiate a game service with the game service module, to provide functionality for defining and adding an anonymous guest player, to receive an input that selects or identifies an anonymous guest player to invite to play the multi-player gaming application on the wireless device, wherein the functionality provides an ability to invite one or more friends that are registered with the game service module and one or more anonymous guest players that are not registered with the game service module.

13. The wireless device of claim 12, wherein the processing system is further configured to execute instructions of the one or more software programs to transferring, with a real-time multiplayer API of the game service module, a function call to send data to players or participants of the multiplayer gaming application.

14. The wireless device of claim 12, wherein the processing system is further configured to execute instructions of the one or more software programs to receive data intended for the anonymous guest player from a different system of the multiplayer gaming application.

15. The wireless device of claim 12, wherein the processing system is further configured to execute instructions of the one or more software programs to receive a notification for the anonymous guest player for a turn-based multiplayer gaming application, wherein the notification indicates that the multiplayer gaming application is ready or waiting for a turn of the anonymous guest player.

16. The wireless device of claim 12, wherein the multiplayer APIs to allow a game developer to develop a multiplayer gaming application for supporting local players only, remote players only, and local players with remote players without having different game modes for each of the local players only, remote players only, and local players with remote players.

17. A computer-implemented method for operating through one or more application programming interfaces (APIs), the computer-implemented method comprises:
initiating a multiplayer gaming application on a system;
receive, with a game service module, a request from the multiplayer gaming application to programmatically locate one or more anonymous guest players; and
programmatically adding, with a multiplayer API of the game service module, an anonymous guest player as a participant or player of the initiated multiplayer gaming application.

18. The computer-implemented method of claim 17, wherein a real-time multiplayer API provides functionality for locating an anonymous guest player for programmatically adding the anonymous guest player to the multiplayer gaming application.

19. The computer-implemented method of claim 18, wherein a user of the system is registered with a game service, wherein the anonymous guest player is assigned a unique identifier and defined as being associated with the user of the system or another player that is registered with the game service

20. The computer-implemented method of claim 17, wherein a turn-based multiplayer API provides the functionality for locating an anonymous guest player for programmatically adding the anonymous guest player to the multiplayer gaming application.

21. The computer-implemented method of claim 17, wherein the one or more APIs to allow a game developer to develop a multiplayer gaming application for supporting local players only, remote players only, and local players with remote players without having different game modes for each of the local players only, remote players only, and local players with remote players.
